(19) United States
(12) Patent Application Publication
(10) Pub. No.: US 2009/0006004 A1
(43) Pub. Date: Jan. 1, 2009

(54) Method for Determining the Identity, Absence and Concentration of a Chemical Compound in a Medium

(75) Inventors: Rudiger Sens, Ludwigshafen (DE); Christos Vamvakaris, Mannheim (DE); Wolfgang Ahlers, Lambsheim (DE); Erwin Thiel, Wilnsdorf (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/159,005

(22) PCT Filed: Dec. 27, 2006
(86) PCT No.: PCT/EP2006/070222

§ 371 Date: Jun. 24, 2008

(30) Foreign Application Priority Data
Dec. 29, 2005 (DE) 10 2005 062 910.5

(51) Int. Cl. G01N 21/00

(52) U.S. Cl. 702/23

(57) ABSTRACT

A method is proposed for detecting at least one chemical compound V contained in a medium (312). The method comprises a verification step (420) which is used to determine whether V is contained in the medium (312). The method furthermore comprises an analysis step (424) in which a concentration c of the at least one chemical compound V is determined.

The verification step comprises the following substeps:
(a1) the medium (312) is exposed to a first analysis radiation (316) of a variable wavelength λ, the wavelength λ assuming at least two different values;
(a2) at least one spectral response function A(λ) is generated with the aid of the radiation (324) absorbed and/or emitted and/or reflected and/or scattered by the medium (312) in response to the first analysis radiation (316);
(a3) at least one spectral correlation function K(δλ) is formed by spectral comparison of the at least one spectral response function A(λ) with at least one pattern function R(λ+δλ), the at least one pattern function R(λ) representing a spectral measurement function of a medium (312) containing the chemical compound V and δλ being a coordinate shift;
(a4) the at least one spectral correlation function K(δλ) is examined in a pattern recognition step (418), and a conclusion is made as to whether the at least one chemical compound V is contained in the medium (312);

The analysis step (424) comprises the following substeps:
(b1) the medium (312) is exposed to at least one second analysis radiation (318) having at least one excitation wavelength λ_{EX};
(b2) at least one spectral analysis function B(λ_{EX},λ_{RES}) is generated with the aid of the radiation (326) of the response wavelength λ_{RES} absorbed and/or emitted and/or reflected and/or scattered by the medium (312) in response to the second analysis radiation (318) of the wavelength λ_{EX} and the concentration c is deduced therefrom.

The invention relates to a method for detecting at least one chemical compound V contained in a medium, the method comprising a verification step for detecting whether the compound is contained in the medium, as well as an analysis step in which the concentration of the chemical compound is determined. The invention also relates to a device for carrying out the method, as well as to the use of the method for checking the authenticity of goods or for identifying a mineral oil.

A multiplicity of methods are employed in order to identify or examine chemical compounds. A large number of the analysis methods use a very wide variety of analysis radiation, which experiences a change in its original intensity as a function of the respective wavelength of the analysis radiation by absorption, emission (for example fluorescence or phosphorescence), reflection and/or scattering. This change can be used in order to deduce the presence or absence of a chemical compound in a medium and/or in order to determine the concentration of the chemical compound in the medium. Many devices are commercially available for this purpose, for example various types of spectrometers.

However, all the devices known from the prior art suffer from various disadvantages which, in particular, greatly compromise usability in practical serial use. For example, one disadvantage is that in many cases the chemical compounds to be detected are present only at an extremely low concentration in the medium to be examined. In general, the signals generated by the chemical compound per se are accordingly weak, so that they are often swamped by the background signals of the medium since the signal-to-noise ratios are correspondingly poor.

Another disadvantage is that, in the commercial devices available, the concentration detection is carried out independently of whether or not the chemical compound is contained in the medium at all. Accordingly, it is therefore difficult to decide in the subsequent evaluation whether for example an extremely weak signal with a poor signal-to-noise ratio is actually attributable to the chemical compound to be detected, or whether it is merely a background signal. Such detection methods are correspondingly unsuitable for being automated since, for example, a computer will always try to determine a concentration independently of the quality of the signal generated. In many cases, such an automated method will therefore generate very unreliable results without an experimenter actually being informed about this unreliability.

Another disadvantage of the known devices and methods is that the equipment outlay and the time taken for a measurement are generally very great so that, for example, such methods and devices are difficult to use for “in situ” analysis, for example in a production plant or a chemical storage facility. It is instead generally necessary to take corresponding samples, which are subsequently analyzed in an analysis laboratory with the aid of the corresponding devices and methods. Such outlay is often intolerable, particularly when there are a multiplicity of samples and a rapid response to particular questions is required.

It is therefore an object of the present invention to provide a method and device which avoid the disadvantages of the methods and devices known from the prior art and allow reliable detection of a chemical compound V.

The proposed method is used for detecting at least one chemical compound V contained in a medium. A fundamental idea of the present invention consists in subdividing the method into a verification step and an analysis step. The verification step is used to determine whether V is contained in the medium. In the analysis step, the concentration of the at least one chemical compound V is determined.

A medium is intended to mean any substance which in principle allows distribution of the chemical compound V. The chemical compound V need not necessarily be distributed homogeneously, although a homogeneous distribution makes it easier to carry out the method since in this case the determination of the concentration c does not depend on the position where the method is carried out in the medium. For example, the medium may comprise gases, paste-like substances such as creams, liquids such as pure liquids, liquid mixtures, dispersions and paints, as well as solids such as plastics. Solids in the broader sense also include superficial coatings of any substrates, for example objects used in daily life, automobiles, building walls etc., for example with cured coatings.

As regards the proposed method, there is also great flexibility with respect to the at least one chemical compound V. For example, the at least one chemical compound may be an organic or inorganic substance. In practice, the type of chemical compound V will depend on the type of medium which is involved. In the case of gaseous media, for example, the chemical compounds V are often gases or vapors. A homogeneous distribution is often set up automatically in this case. A homogeneous distribution may also be achieved by suitable measures so that, for example, even fine solid particles can be distributed, in particular dispersed in a liquid or gaseous medium. In the case of paste-like or liquid media, the chemical compounds V are usually molecularly dissolved or present as finely divided solid particles, separation of solid particles generally taking place only rarely in paste-like media owing to the high viscosity compared with gaseous or liquid media.

In the case of liquid media, a homogeneous distribution of the solid particles may be achieved by suitable measures while carrying out the method, for example the presence of dispersants and/or continuous mixing. If the liquid media are dispersions or paints, for example, then these are generally already adjusted so that demixing does not take place or takes place only over a prolonged time period. The determination of the measurement function or comparison function can then normally be carried out without problems. Here again, vitiation of the measurement by separation may optionally be counteracted by suitable homogenization measures.

In the case of solid media, such as plastics in particular, the chemical compounds V are usually present as finely divided solid particles or molecularly dissolved. Naturally, demixing phenomena generally do not constitute a problem in this case either.

The two method steps of the proposed method are subdivided into various substeps. The verification step thus firstly comprises a substep in which the medium is exposed to a first analysis radiation of a variable wavelength λ, the wavelength λ assuming at least two different values. For example, the wavelength λ may be tuned continuously over a particular predetermined range, for example by using a tunable beam source, for example a tunable laser and/or a spectrometer. As an alternative or in addition, it is also possible to switch between different discrete values of the wavelength λ. It is for example possible to use and switch between individual beam sources, preferably individual beam sources with a narrowband emission spectrum. Exemplary embodiments will be explained in more detail below.

In a second substep, at least one spectral response function A(λ) is generated with the aid of radiation absorbed and/or emitted and/or reflected and/or scattered by the medium, and/or the at least one chemical compound possibly contained in the medium, in response to the first analysis radiation.

Any radiation which can interact with the at least one chemical compound V, so that a corresponding spectral response function A(λ) can be generated, may be envisaged as the first analysis radiation. It may in particular be electromagnetic radiation, although particle radiation such as neutron or electron radiation, or acoustic radiation such as ultrasound, may also be envisaged as an alternative or in addition.

The detection is also configured according to the first analysis radiation type. The detected radiation need not necessarily be radiation of the same type as the first analysis radiation type. A distinctive wavelength shift may for example take place or, for example with excitation by neutron radiation, it is also possible to measure corresponding y radiation as a response function. In order to provide a method which is as simple as possible, however, both the first analysis radiation and the corresponding detected radiation are preferably radiation in the visible, infrared or ultraviolet spectral range.

Furthermore, the at least one spectral response function A(λ) need not necessarily correspond directly to the at least one detector signal recorded in response to the first analysis radiation. It is also possible to generate spectral response functions A(λ) which are produced only indirectly, for example calculated from one or more detector signals. This will play a part in a refinement of the invention presented below. It is also possible to record a plurality of spectral response functions A(λ) simultaneously, for example a fluorescence signal and absorption signal simultaneously.

In practice, the choice of the at least one spectral response function A(λ) or the choice of the at least one detected signal is dependent on the behavior of the system, in particular of the medium, in relation to the first analysis radiation. With sufficient transparency of the medium for the first analysis radiation, the at least one spectral response function A(λ) may for example represent the absorption or transmission behavior of the system, in particular of the medium. If this transparency is not guaranteed, or guaranteed only to an insufficient extent, then the spectral response function may also constitute a representation of the wavelength-dependent reflection behavior of the system. If the system is excited to emit radiation by the first analysis radiation, then the wavelength-dependent emission behavior may be used as a spectral response function, or in order to generate this spectral response function. A combination of different spectral response functions is furthermore possible. Moreover, the at least one spectral response function may also be measured as a function both of the wavelength of the analysis radiation and of the wavelength of the detection, since the wavelength of the excitation and the detection wavelength need not necessarily be identical.

In a third substep of the verification step, a correlation is subsequently carried out between the at least one spectral response function A(λ) and at least one pattern function R(λ). Such correlations clearly represent a “superposition” of the pattern function and the spectral response function, with the pattern function and spectral response function respectively being shifted by a coordinate shift δλ relative to the wavelength axis and an intersection of the two functions A(λ) and R(λ) being determined for each coordinate shift δλ. Accordingly, a spectral correlation function K(δλ) is formed by means of a known correlation procedure. This correlation procedure may, for example, be carried out computationally or by hardware components.

The at least one pattern function R(λ) may, for example, be a spectral response function of a reference sample. As an alternative or in addition, this at least one pattern function may also comprise analytically determined pattern functions and pattern functions stored in a literature table (for example a collection of known spectra). One or more spectral response functions may be compared with one or more pattern functions, so as to form a corresponding number of spectral correlation functions K(δλ).

A preferred method variant uses the following relation for determining the spectral correlation function K(δλ)

$$K ( δλ ) = \frac{1}{N} \cdot {\int }_{λ} A ( λ ) \cdot R ( λ + δλ ) \cdot d λ . \qquad ( 1 )$$

Here, N represents a normalization factor which is preferably calculated according to

$$N = {\int }_{λ} A ( λ ) \cdot R ( λ ) \cdot d λ \qquad ( 2 )$$

The integration is carried out over a suitable wavelength interval, for example from −∞ to +∞, or over a wavelength interval used for the measurement.

If first analysis radiation with discrete values of the wavelength λ is used instead of continuous first analysis radiation, for example by switching between different beam sources, then it is suitable to form a Riemann sum instead of integrating according to Equations (1) and (2):

$$\begin{matrix}K ( δλ ) = \frac{1}{{N}^{*}} \cdot {\sum }_{i} {A}_{i} ( {λ}_{i} ) \cdot {R}_{i} ( {λ}_{i} + δλ ) \cdot {Δλ}_{i} & ( 3 ) \\ {N}^{*} = {\sum }_{i} {A}_{i} ( {λ}_{i} ) \cdot {R}_{i} ( {λ}_{i} ) \cdot {Δλ}_{i} & ( 4 )\end{matrix}$$

Here, summation is carried out over a number of support points i and Δλᵢ represents an interval length of respectively suitable intervals. N is a normalization factor corresponding to the continuous N. Such Riemann sums are known to the person skilled in the art.

Besides the methods presented here for determining the at least one spectral correlation function K(δλ), other correlation functions which may be employed for comparing the at least one spectral response function A(λ) with the at least one pattern function R(λ) are also known from the prior art and from mathematics.

From the existence of the at least one spectral correlation function K(δλ), in a fourth substep of the verification step it is now possible to obtain information as to whether the at least one chemical compound V is contained in the medium. If a spectral response function of the chemical substance to be detected is used as at least one pattern function R(λ), for example, then the pattern function and the spectral response function correlate well. If the spectral response function has a sharp, i.e. in the ideal case infinitely narrow maximum (peak) at a particular wavelength, for example, the spectral correlation function K(δλ) has an infinitely narrow peak of unit height at the wavelength δλ=0 and is otherwise equal to zero. With a finite width of the spectral response function as regularly occurs in practice, the correlation function also broadens correspondingly.

Despite a finite width of the at least one spectral correlation function K(δλ) as occurs in reality, information about whether the at least one chemical compound V is contained in the medium can be obtained from the at least one spectral correlation function by means of a pattern recognition step. In particular, the at least one spectral correlation function K(δλ) will have a characteristic maximum in the vicinity of δλ=0 (in the ideal case exactly at δλ=0, see below) and subsequently fall off (to the right and left of the zero). Since the spectral response function of the chemical compounds to be detected are generally known (for example from comparative measurements or from corresponding databases), it is also possible to correspondingly predict the profile of the at least one spectral correlation function K(δλ) and deliberately search for the presence of this spectral correlation function K(δλ) in the pattern recognition step. For example, this search in the pattern recognition step may be carried out with the aid of commercially available pattern recognition software, for example with the aid of corresponding pattern recognition algorithms. “Digital” information about whether the at least one chemical compound V is contained in the medium need not necessarily be obtained, rather it is also possible to generate for example probabilities for the presence of this at least one chemical compound or for some of these at least one chemical compounds. For example, an intermediate result that a particular chemical compound V is present in the medium with a probability of 80% may be output to an experimenter.

The verification step is concluded by carrying out the pattern recognition step. It should nevertheless be pointed out that the verification step may also comprise other substeps, and that the described substeps need not necessarily be carried out in the order mentioned.

The analysis step, which is preferably carried out separately from the verification step, in turn comprises at least two substeps. The substeps of the analysis step which are described below likewise need not necessarily be carried out in the order presented, and other substeps may be added. The method may furthermore contain other method steps besides the analysis step and the verification step.

In a first substep of the analysis step, the medium is exposed to at least one second analysis radiation having at least one excitation wavelength λ_{EX}. The above comments about the first analysis radiation apply correspondingly to the second analysis radiation. Again, instead of one analysis radiation, it is also possible to use a plurality of beam sources simultaneously, alternately or sequentially. The second analysis radiation may also be analysis radiation identical to the first analysis radiation so that, in particular, it is even possible to use the same beam source. In contrast to the first analysis radiation, however, a variation of the excitation wavelength λ_{EX} is not necessarily required here, so that it is also possible to use a beam source with a rigidly predetermined excitation wavelength λ_{EX} in order to generate information about the concentration c. In practice, however, the excitation wavelength λ_{EX} of the second analysis radiation will also comprise at least two different wavelengths, for example again by continuous scanning through a wavelength range or by switching between two or more wavelengths.

In a second substep of the analysis step, the concentration c of the at least one chemical compound V is deduced with the aid of the radiation absorbed and/or emitted and/or reflected and/or scattered by the medium, and/or the at least one chemical compound possibly contained in the medium, in response to the second analysis radiation of the wavelength λ_{EX}. At least one spectral analysis function B(λ_{EX}, λ_{RES}) is generated for this purpose, λ_{RES} being the response wavelength of the medium and/or the at least one chemical compound. Similarly as the at least one spectral response function A(λ) mentioned above, the at least one spectral analysis function B(λ_{EX}, λ_{RES}) need not necessarily be directly a detector signal, rather it is again possible for example first to carry out a transformation (for example reprocessing by means of a computer or a filter) or another rearrangement. It is also possible to record a plurality of spectral analysis functions B(λ_{EX}, λ_{RES}), for example a transmission function and a fluorescence function.

The at least one spectral analysis function, as represented, is a function both of the excitation wavelength λ_{EX} and of the response wavelength λ_{RES}. For example, it is possible to measure at different response wavelengths λ_{RES} for each individual excitation wavelength λ_{EX}. It is nevertheless suitable to record the spectral analysis function B(λ_{EX}, λ_{RES}) integrally over a wavelength range of the response wavelength λ_{RES}, for example by means of a broadband detector. Moreover, the at least one excitation wavelength λ_{EX} is preferably “stopped out” so that it is not contained, or is contained only at a suppressed level, in the recorded wavelength range of the response wavelength λ_{RES}. This may for example be done by a corresponding filter technique, the excitation wavelength λ_{EX} being filtered out. Edge filters, bandpass filters or polarization filters may for example be used for this. In this way, the at least one spectral analysis function is recorded integrally over a response wavelength range merely as a function of the excitation wavelength λ_{EX}. This makes it much simpler to evaluate the signals.

The concentration c of the at least one chemical compound V is now deduced from the at least one spectral analysis function B(λ_{EX}, λ_{RES}). This step is carried out using a known relation c=f(B) between the spectral analysis function B(λ_{EX}, λ_{RES}) and the concentration c of the chemical compound V in the medium. For example, the relation f between the spectral analysis function B(λ_{EX}, λ_{RES}) and the concentration c may be determined empirically. A corresponding comparison data set, for example, generated e.g. from reference and/or calibration measurements, is to this end stored in a table. In many cases, the relation f is also analytically known (at least approximately). For example, fluorescence signals are at least approximately proportional directly to the concentration of the at least one chemical compound to be detected. The concentration can likewise be deduced from absorption signals by using the Lambert-Beer law.

One problem in general, however, is that the at least one spectral analysis function B(λ_{EX}, λ_{RES}) will generally have only very weak signals, since the at least one chemical content to be detected is often contained only at a very low concentration in the medium. Accordingly, the signal-to-noise ratio and therefore the results generated are poor. Another problem is that background signals are present since, for example, the medium itself contributes to the spectral analysis function B(λ_{EX}, λ_{RES}) in the corresponding wavelength range. This problem can be reduced in various ways. For example, background signals of the at least one spectral analysis function may be empirically determined and e.g. tabulated beforehand, for example by corresponding measurements being carried out on media which do not contain the at least one chemical compound. Such background signals can be subtracted from the at least one spectral analysis function before the at least one spectral analysis function is evaluated, and thus before the concentration is determined. The at least one spectral analysis function may also be reprocessed as an alternative or in addition, for example by the use of corresponding filters. The aforementioned integral recording of the at least one spectral analysis function over a predetermined wavelength range of the response wavelength λ_{RES} also contributes to an increase in the signal strength and therefore to reliability of the evaluation.

In a particularly preferred alternative embodiment of the method according to the invention, a lock-in method is used as an alternative or in addition. In this case, the second analysis radiation is modulated periodically with a frequency f. Such lock-in methods are known from other fields of spectroscopy and electronics. For example, the at least one spectral analysis function may then also be recorded with time resolution as B(λ_{EX}, λ_{RES}, t). Integral recording over a wavelength range of the response wavelength λ_{RES} is also possible so that, in this case, the at least one spectral analysis function is recorded with time resolution as B(λ_{EX}, t). The modulation frequency may, for example, lie in the range of between a few tens of Hz and a few tens of kHz. When using electromagnetic radiation (for example in the visible, infrared or ultraviolet spectral range), for example, the modulation may be generated by using a so-called chopper in the beam path of the at least one second analysis radiation.

Standard radiofrequency techniques, which only evaluate signals at (i.e. within a predetermined spectral vicinity of) the modulation frequency f from the frequency spectrum of the at least one spectral analysis function, may then be used for evaluating the at least one spectral analysis function B(λ_{EX}, λ_{RES}, t). Such radiofrequency techniques comprise, for example, frequency mixers by means of which the at least one spectral analysis function is mixed with a signal at the modulation frequency f, followed by corresponding filters, in particular lowpass filters.

Mathematical evaluation is also possible. For example, at least one filtered spectral analysis function B(λ_{EX}, λ_{RES}, t) may first be generated from the at least one spectral analysis function according to the following equation:

$$B ( τ , {λ}_{EX} , {λ}_{RES} ) = {\int }_{0}^{τ} B ( {λ}_{EX} , {λ}_{RES} , t ) \cdot cos ( 2 π \cdot f \cdot t ) d t . \qquad ( 9 )$$

Here, τ represents a time constant which, for example, corresponds to the edge of an edge or bandpass filter. The spectral analysis function B(τ, λ_{EX}, λ_{RES}) filtered in this way is cleaned greatly compared with the original signal B(λ_{EX}, λ_{RES}, t), since this filtered signal now contains noise and perturbing signals only in a very narrow frequency interval (approximately of width 1/τ) around the modulation frequency f.

As described above, the concentration of the at least one chemical compound in the medium can subsequently be deduced from the thereby cleaned, filtered signal B(τ, λ_{EX}, λ_{RES}) by using the general, for example empirically determined or analytically derived relation c=f(B). In the case of a fluorescence signal, for example, the concentration c may be deduced via a (for example empirically determined or tabulated) first proportionality constant K₁ by means of the equation

c=K₁·B(τ,λ_{EX},λ_{RES}) (7)

The case of an absorption signal, for example, the concentration may be deduced by means of a second proportionality constant K₂, for example by means of the relation

c=K₂·log B(τ,λ_{EX},λ_{RES}), (8)

which corresponds to a rearrangement of the Lambert-Beer law.

In this way, by using the described method in one of the described variants, not only is it possible to determine rapidly and reliably whether the at least one chemical compound V is contained in the medium, but it is likewise subsequently possible to determine the concentration. In particular, the method may be carried out in such a way that the analysis step is performed only if the verification the step has established that the compound V is actually contained in the medium. This contributes to the possibility of automating the described method in a straightforward and reliable way, in which case a corresponding intermediate result may be output (for example concerning the presence or absence of a particular chemical compound). Automation of the method, for example by means of a corresponding computers and computer algorithms, is also possible in a straightforward and reliable way.

The method according to the invention may also be further refined in various ways. A preferred refinement relates to the described method step in one of the alternative embodiments presented, and relates in particular to the problem that the medium itself may have an effect on the at least one spectral response function A(λ). In particular, the at least one spectral response function A(λ) may comprise signal components which originate not from the at least one chemical compound to be detected, but from the medium itself and/or impurities contained in the medium. Such signal components cause a background signal in the at least one spectral response function A(λ).

Another problem is that the matrix of the medium may also cause a shift of the at least one spectral response function A(λ). In particular, this is attributable to the fact that the matrix of the medium exerts a molecular or atomic influence on the at least one chemical compound, and therefore on the spectral properties of this at least one chemical compound. One variant of this effect is so-called solvatochromicity, an effect which causes the spectrum of a compound to be shifted under the influence of a solvent (medium) so that, for example, characteristic maxima of the spectra become shifted in wavelength.

According to the invention, these effects can be countered if at least one raw response function A′(λ′) is firstly recorded instead of or in addition to the at least one spectral response function A(λ). This at least one raw response function is subsequently transformed into the at least one spectral response function A(λ) according to the equation:

A(λ)=A′(λ′)−H(λ′). (5)

Here, λ is a shift-corrected wavelength, in particular a wavelength corrected for a solvatochromicity effect, which is calculated for example according to:

λ=λ′+Δλ_{S}. (6)

Here, Δλ_{S} is a predetermined wavelength shift (solvatochromicity shift) which for example may be empirically determined beforehand, may be tabulated or may also be determined by means of corresponding quantum mechanical calculations.

For example, a spectral response function of a medium containing the compound V may be compared with a spectral response function of a reference medium containing the compound V and/or with a reference response function. The wavelength shift Δλ_{S} can be correspondingly determined from a shift.

In an alternative method, a spectral correlation function K(δλ) is used similarly as the spectral correlation function described above. A correlation is formed between a spectral response function of a medium containing the compound V and a spectral response function of another medium (reference medium) which likewise contains the compound V. A standard response function may also be used instead of the second spectral response function. Since the two spectra are now shifted relative to each other, for example because of said solvatochromicity effect and the influence of the medium on the spectral properties of the compound V, the maximum of the spectral correlation will no longer lie at δλ=0. Instead, it will be shifted by the wavelength shift Δλ_{S} relative to the zero on the wavelength axis. It is therefore possible to determine Δλ_{S} from this shift of the maximum of the spectral correlation function K(δλ) relative to the zero. In this way, even in an automated method, it is readily possible to determine the wavelength shift Δλ_{S} by utilizing said correlation function K(δλ), without an experimenter necessarily having to intervene. As described above, however, in addition or as an alternative, it is also possible for different values of wavelength shifts Δλ_{S} to be logged and tabulated for various known media, and called up and used as required.

As an alternative or in addition to the described correction of the wavelength shift, the background will also be corrected or at least reduced as shown in Equation (5). The background function H(λ′) is used for this purpose. There are also various suitable methods for determining this background function H(λ′). On the one hand, it is likewise possible to tabulate various background functions, for example empirically determined background functions. For example, a spectral response function of the medium containing the compound V may be compared with a spectral response function of the medium not containing the compound V and/or with a reference response function, in particular simply by taking the difference. The spectral background function H(λ′) can be determined from this deviation, for example in the form of a fit function, in particular a fitted polynomial or a similar function. Such fitting routines are commercially available and form part of many analysis algorithms. The resulting spectral background functions may, for example, be stored and called up as required.

As an alternative or in addition, it is likewise possible to use a correlation for determining the spectral background function H(λ′). For example, a transformation of a raw response function A′(λ′) into a spectral response function A(λ) may firstly be carried out, according to Equation (5) (see above). A particular set of parameters are for example assumed for a background function (or as an alternative or in addition also for the wavelength shift Δλ_{S}) for example as a result of fitting a fit function, for example a polynomial, to a background. After carrying out this transformation with the assumed parameter set, a correlation function is subsequently determined according to the equation

$$K ( δλ ) = \frac{{\int }_{λ} A ( λ ) \cdot R ( λ + δλ ) \cdot d λ}{{\int }_{λ} A ( λ ) \cdot R ( λ ) \cdot d λ} \qquad ( 10 )$$

This correlation function K(δλ) corresponds to Equation (1), but now with a transformed spectral response function A(λ). A reference correlation function K_{Auto}(δλ) is subsequently formed according to the following equation:

$${K}_{Auto} ( δλ ) = \frac{{\int }_{λ} R ( λ ) \cdot R ( λ + δλ ) \cdot d λ}{{\int }_{λ} R ( λ ) \cdot R ( λ ) \cdot d λ} \qquad ( 11 )$$

This second spectral correlation function K_{Auto}(δλ) corresponds to an autocorrelation of the at least one pattern function R(λ) with itself. In the ideal case, the correlation function K(δλ) precisely corresponds to the autocorrelation function K_{Auto}(δλ). The parameter set selected for the at least one background function (and optionally, as an alternative or in addition, also for the wavelength shift Δλ_{S}) can thus be optimized such that K(δλ) is approximated to K_{Auto}(δλ). The better the match is, the better is the choice of the parameter set. This method can be readily automated mathematically, for example by employing known mathematical methods (for example of the method of least squares). It is also possible to define threshold values, in which case the iterative optimization will be terminated when the function K(δλ) matches the correlation function K_{Auto}(δλ) to within predetermined threshold values (or better).

The method according to the invention, or a device according to the invention for carrying out the method, in one of the aforementioned configurations has many advantages over known methods and devices. In particular, one advantage resides in the straightforward automation of the described method. The method can thus be readily automated and integrated in small, easily handleable measuring equipment which, in particular, can also be used in situ. The analysis by means of the described method is nevertheless robust and reliable, since even the described perturbing influences can be eliminated or at least greatly reduced.

On the one hand, the method according to the invention can therefore be used for more accurate determination of the concentration of constituents in a very wide variety of media. Inter alia, it may be used for the determination of pollutants, for example nitrogen oxides, sulfur dioxide or finely divided substances suspended in the atmosphere.

On the other hand, the method according to the invention may also be employed in order to determine the authenticity or non-authenticity of a medium, which contains the at least one chemical compound V as a labeling substance. A constituent already present may be used as the chemical compound, although labeling substances may also be added separately. A particular advantage in this case is that the labeling substance can be added in amounts so small that it is identifiable neither visibly nor by conventional spectroscopic analysis methods. The method according to the invention can therefore be used to determine the authenticity of a correspondingly labeled product package, mineral oils and/or to check the authenticity of goods, or in order to discover the existence of (possibly illegal) manipulations.

Byproducts due to the production of the medium, or traces of catalysts which have been used during production of the media (for example solvents, dispersions, plastics etc.) may furthermore be detected as chemical compounds V. In natural products, for instance plant oils, it is possible to detect substances which are for example typical of the cultivation site of the plants (for example ones yielding oil). By determining the identity or non-identity of these substances, it is therefore possible to confirm or deny the origin of the natural product, for example the oil. Similar considerations also apply for example to types of petroleum, which have a spectrum of typical minor constituents dependent on the petroleum reservoir.

If at least one chemical compound V is intentionally added to the medium, for example a liquid, then it is possible for the medium labeled in this way to be determined as authentic, or to identify possible manipulations. Fuel oil, which usually has tax concessions, can for example be distinguished in this way from diesel which is generally taxed more heavily, or liquid product streams in large industrial plants, for example petroleum refineries, can be labeled and thereby tracked. Since the method according to the invention makes it possible to determine very low concentrations of the at least one chemical compound V, this can be added to the medium in a correspondingly low concentration. A possible negative effect due to the presence of the compound, for example when burning fuel oil or diesel, can be substantially precluded.

In a similar way, for example, spirits can be marked so as to distinguish properly manufactured, taxed and sold alcoholic beverages from illegally manufactured and sold goods. Naturally, chemical compounds V which are safe for human consumption should be used for the labeling in this case.

It is furthermore possible to use at least one chemical compound V for labeling plastics or coatings. This may, for example, be done in order to determine the authenticity or non-authenticity of the plastics or coatings, or in order to guarantee properly sorted classification of used plastics with a view to recycling them. The increased sensitivity of the method according to the invention is advantageous in this case as well, since the at least one chemical compound V, for example a dye, can be added in only very small amounts and does not therefore affect the visual appearance of the plastics or coatings, for example.

The method according to the invention has a particularly preferred application for determining the identity or non-identity of at least one chemical compound V′ distributed homogeneously in a liquid medium.

Particular examples which may be mentioned for liquid media are organic liquids and their mixtures, for example alcohols such as methanol, ethanol, propanol, isopropanol, butanol, isobutanol, sec-butanol, pentanol, isopentanol, neopentanol or hexanol, glycols such as 1,2-ethylene glycol, 1,2- or 1,3-propylene glycol, 1,2-, 2,3- or 1,4-butylene glycol, di- or triethylene glycol or di- or tripropylene glycol, ethers such as methyl tertbutyl ether, 1,2-ethylene glycol mono- or dimethyl ether, 1,2-ethylene glycol mono- or diethyl ether, 3-methoxypropanol, 3-isopropoxypropanol, tetrahydrofuran or dioxane, ketones such as acetone, methyl ethyl ketone or diacetone alcohol, esters such as methyl acetate, ethyl acetate, propyl acetate or butyl acetate, aliphatic or aromatic hydrocarbons such as pentane, hexane, heptane, octane, isooctane, petroleum ether, toluene, xylene, ethylbenzene, tetralin, decalin, dimethylnaphthalene, petroleum spirit, mineral oils such as gasoline, kerosene, diesel or fuel oil, natural oils such as olive oil, soybean oil or sunflower oil, or natural or synthetic motor, hydraulic or gear oils, for example vehicle engine oil or sewing machine oil, or brake fluids. They are also intended to include products which are obtained by processing particular types of plant, for example rape or sunflower. Such products are also known by the term “bio-diesel”.

According to the invention, the method has an application in particular for determining the identity or non-identity and the concentration of at least one chemical compound V in mineral oil. In this case, the at least one chemical compounds are particularly preferably labeling substances for mineral oils.

Labeling substances for mineral oil are usually substances which exhibit absorption both in the visible and in the invisible wavelength range of the spectrum (for example in the NIR). A very wide variety of compound classes are proposed as labeling substances, for example phthalocyanine, naphthalocyanine, nickel-dithiolene complexes, aminium compounds of aromatic amines, methine dyes and azulene squaric acid dyes (e.g. WO 94/02570 A1, WO 96/10620 A1, prior German patent application 10 2004 003 791.4), but also azo dyes (e.g. DE 21 29 590 A1, U.S. Pat. No. 5,252,106, EP 256 460 A1, EP 0 509 818 A1, EP 0 519 270 A2, EP 0 679 710 A1, EP 0 803 563 A1, EP 0 989 164 A1, WO 95/10581 A1, WO 95/17483 A1). Anthraquinone derivatives for coloring/labeling gasoline or mineral oils are described in documents U.S. Pat. No. 2,611,772, U.S. Pat. No. 2,068,372, EP 1001 003 A1, EP 1323 811 A2 and WO 94/21752 A1 as well as prior German patent application 103 61 504.0.

Substances which do not lead to a visually or spectroscopically identifiable color reaction until after extraction from the mineral oil and subsequent derivatization are also described as labeling substances for mineral oil. Such labeling substances are for instance aniline derivatives (e.g. WO 94/11466 A1) or naphthylamine derivatives (e.g. U.S. Pat. No. 4,209,302, WO 95/07460 A1). With to the method according to the invention, it is possible to detect the aniline or naphthylamine derivatives without prior derivatization.

Extraction and/or derivatization of the labeling substance in order to obtain an increased color reaction or to concentrate the labeling substance so that its color can be better determined visually or spectroscopically, as sometimes mentioned in the cited documents, is also possible according to the present method but generally unnecessary.

Document WO 02/50216 A2 discloses inter alia aromatic carbonyl compounds as labeling substances, which are detected UV-spectroscopically. With the aid of the method according to the invention, it is possible to detect these compounds at much lower concentrations.

The labeling substances described in the cited documents may of course also be used for labeling other liquids, such liquids already having been mentioned above by way of examples.

### EXAMPLES

Correlation-spectroscopically different anthraquinone dyes were studied as labeling substances for mineral oil.

### A) Preparation of the Anthraquinone Dyes

### Example 1

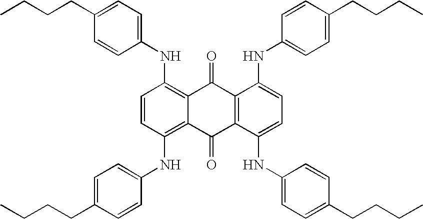

(CAS-No.: 108313-21-9, molar mass: 797.11; C₅₄H₆₀N₄O₂λₘₐₓ=760 nm (toluene))

1,4,5,8-Tetrakis[(4-butylphenyl)amino]-9,10-anthracenedione was synthesized similarly as in document EP 204 304 A2.

To this end 82.62 g (0.5370 mol) of 4-butylaniline (97% strength) were prepared, 11.42 g (0.0314 mol) of 1,4,5,8-tetrachloroanthraquinone (95.2% strength), 13.40 g (0.1365 mol) of potassium acetate, 1.24 g (0.0078 mol) of anhydrous copper(II) sulfate and 3.41 g (0.0315 mol) of benzyl alcohol were added and the batch was heated to 130° C. It was stirred for 6.5 h at 130° C., then heated to 170° C. and stirred for a further 6 h at 1700C. After cooling to 60° C., 240 ml of acetone were added, then it was suction-filtered at 25° C. and the residue was washed first with 180 ml of acetone and then with 850 ml of water until the filtrate had a conductance of 17 μS. The washed residue was finally dried. 19.62 g of product were obtained, corresponding to a yield of 78.4%.

The compounds listed below were synthesized in an entirely similar way by reacting 1,4,5,8-tetrachloroanthraquinone with the corresponding aromatic amines:

### Example 2

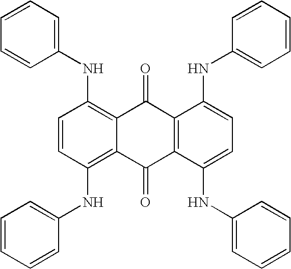

### Example 3

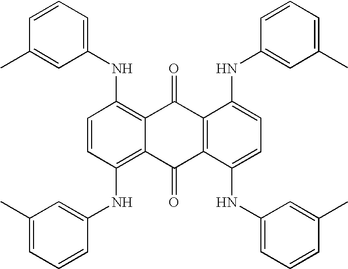

### Example 4

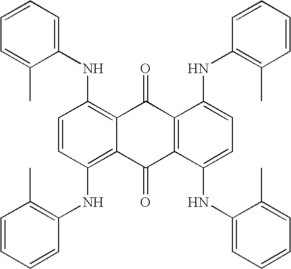

### Example 5

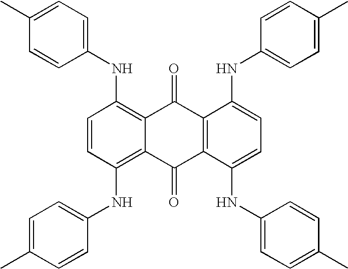

### Example 6

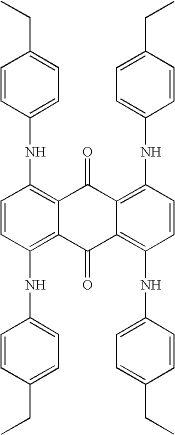

### Example 7

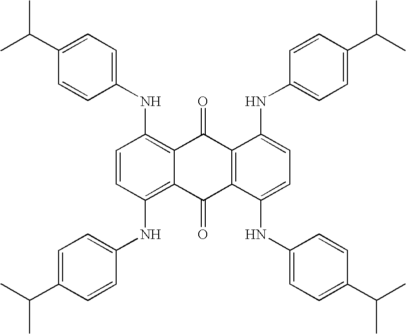

### Example 8

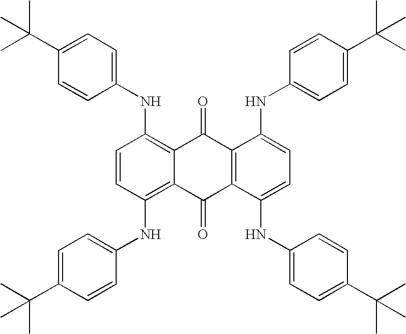

### Example 9

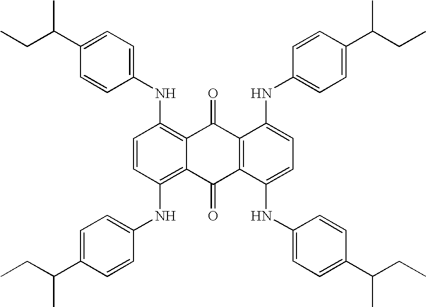

### Example 10

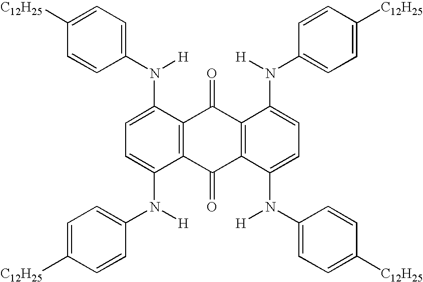

### Example 11

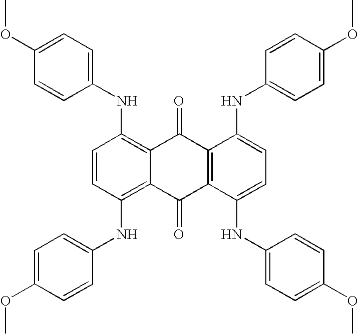

Other advantages and configurations of the invention will now be explained with reference to the following exemplary embodiments, which are represented in the figures. The invention is not, however, restricted to the exemplary embodiments which are represented.

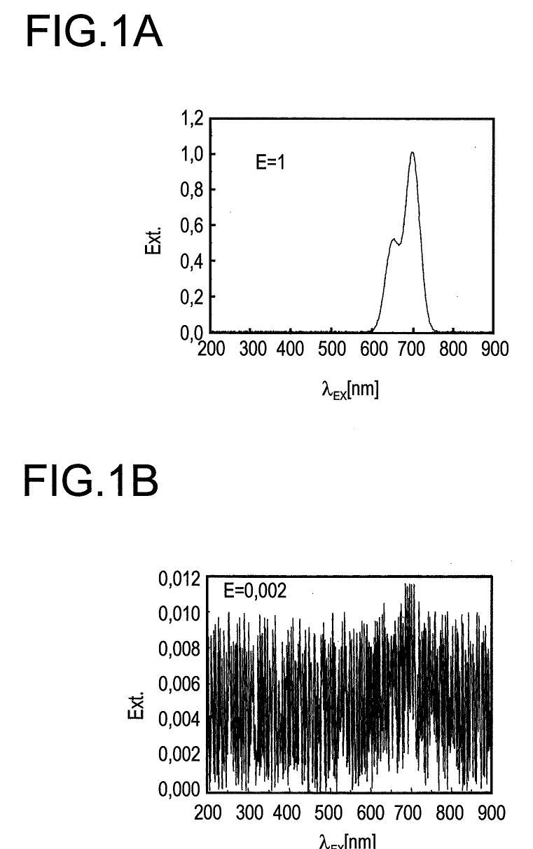

FIG. 1A shows an absorption spectrum of a cationic cyanine dye at a relative concentration of 1;

FIG. 1B shows an absorption spectrum of a cationic cyanine dye according to FIG. 1A at a relative concentration of 0.002;

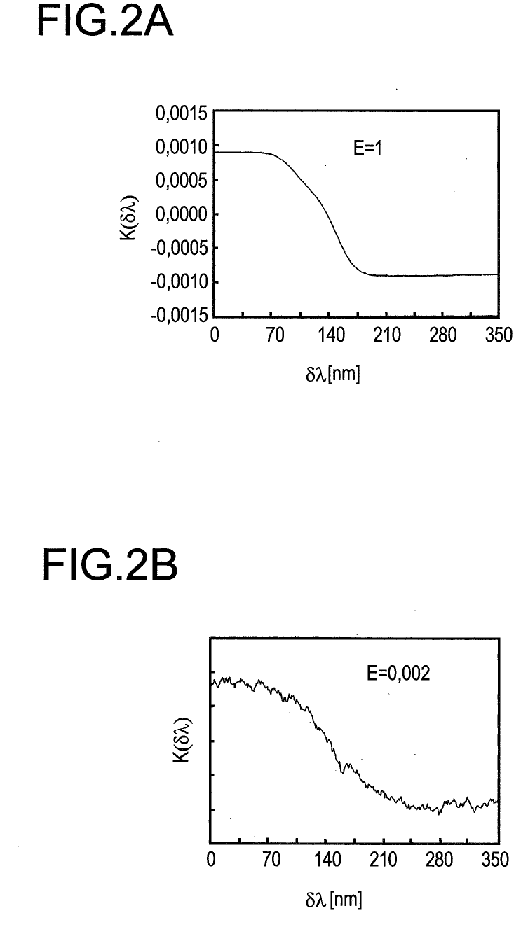

FIG. 2A shows a correlation function of the spectrum according to FIG. 1A;

FIG. 2B shows a correlation spectrum according to FIG. 2A of the absorption spectrum according to FIG. 1B;

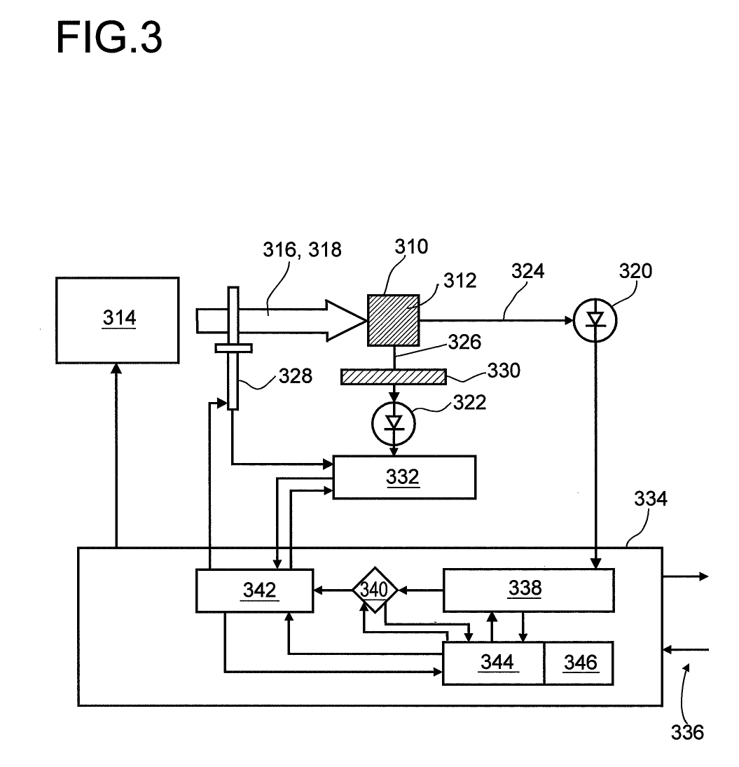

FIG. 3 shows an exemplary embodiment of a device according to the invention for carrying out the method according to the invention;

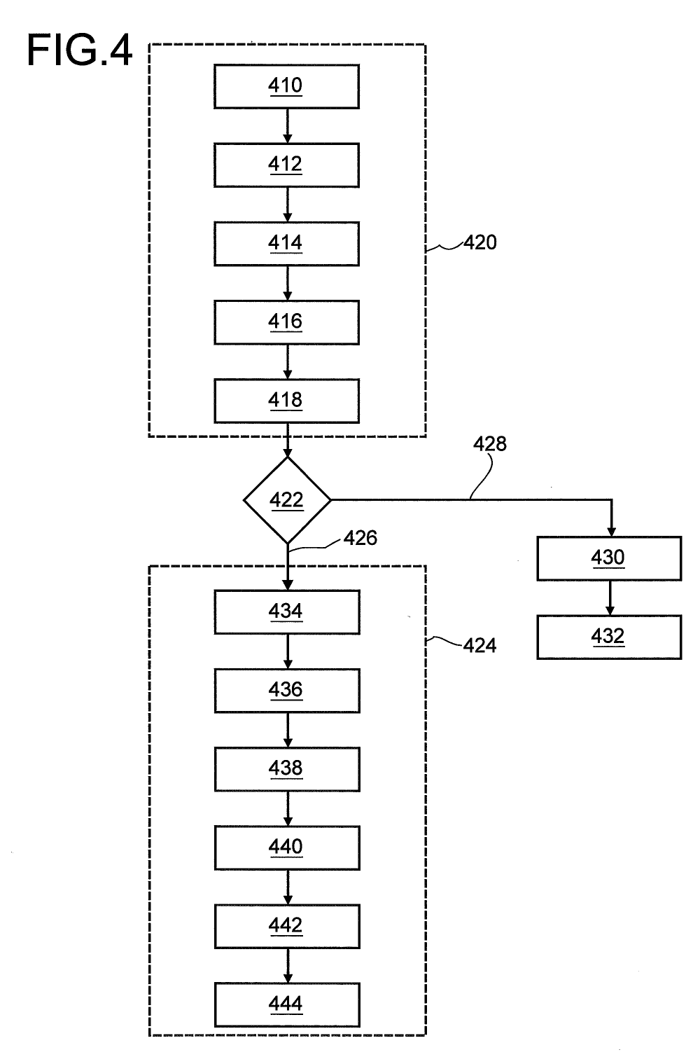

FIG. 4 shows a schematic flow chart of an example of the method according to the invention;

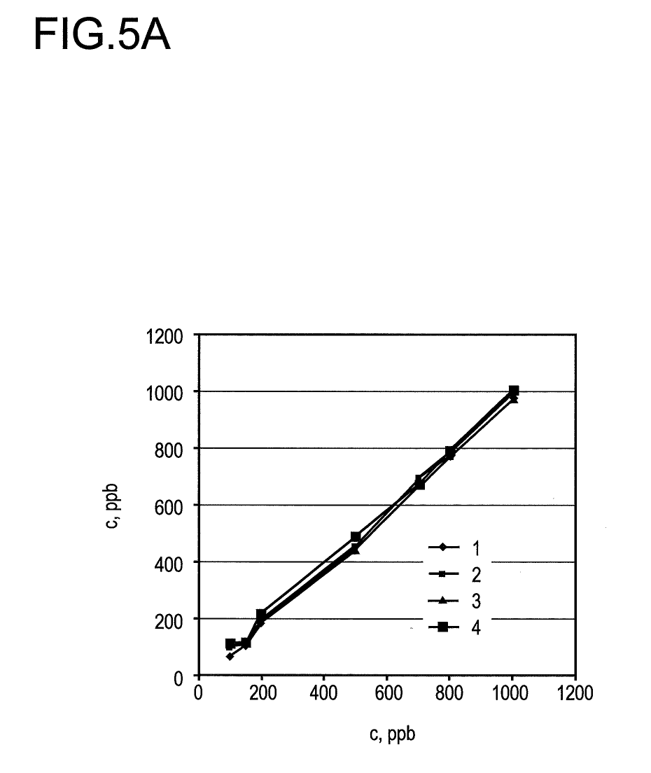

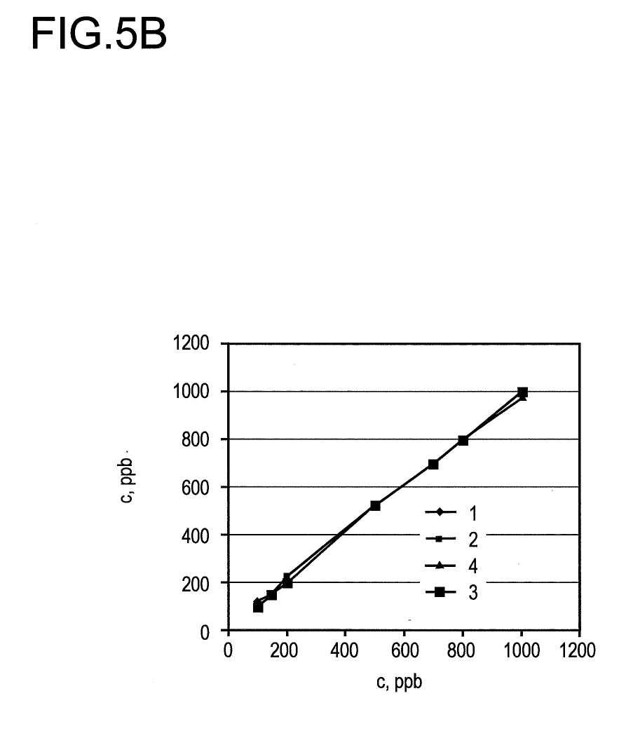

FIG. 5A shows an example of a concentration-absorption measurement on the anthraquinone dye according to the above Example 1 in diesel fuel; and

FIG. 5B shows an example of a concentration-fluorescence measurement on the anthraquinone dye according to the above Example 1 in diesel fuel.

FIGS. 1A and 1B represent absorption spectra of a cationic cyanine dye at two different concentrations. The concentration of the cyanine dye in FIG. 1B is merely 0.002 of the concentration of the cyanine dye in FIG. 1A. As can be seen in FIG. 1A, this cyanine dye has a sharp absorption maximum, here denoted by “Ext.”, at approximately 700 nm. The absorption has been normalized to this maximum in the representation according to FIG. 1A, the absorption value of this maximum having been arbitrarily scaled to the value 1. The absorption in FIG. 1B has been scaled with the same scaling factor, and is therefore comparable with the absorption according to FIG. 1A. The excitation wavelength is denoted by λ_{EX}. It can be seen that with the concentration of the cyanine dye in FIG. 1B, which is 500 times less compared with FIG. 1A, the originally sharp absorption band at 700 nm is entirely swamped by the noise. In this test, therefore, even with such dilution, it is no longer possible to predict reliably whether any cyanine dye (compound) is actually contained in the solution (medium) in this case.

Conversely, correlation spectra of the test according to FIGS. 1A and 1B are plotted in FIGS. 2A and 2B. The plot here is in arbitrary units. The correlation spectrum K(δλ) in FIG. 2A corresponds to the spectrum according to FIG. 1A, and the correlation function K(δλ) of the plot in FIG. 2B corresponds to the representation in FIG. 1B. The correlation of functions are respectively plotted as a function of the wavelength shift δλ.

The correlation functions in FIGS. 2A and 2B are represented in arbitrary units in this exemplary embodiment. The aforementioned Equation (1) was used for calculating the correlation functions. The spectrum according to the representations in FIGS. 1A and 1B was respectively used as the spectral response function A(λ). A stored “clean” absorption function of the cyanine dye was used as the pattern function R(λ), i.e. in particular an absorption function for a sufficient concentration which has a good signal-to-noise ratio. In this specific example, the absorption function according to FIG. 1A was itself used as a pattern function R(λ). Normalization with a factor N was omitted in this case, so that the plot here is in arbitrary units.

In this example, therefore, the correlation function K(δλ) in the example in FIG. 2A represents a so-called autocorrelation function since the correlation of the spectrum according to FIG. 1A with itself has been determined. A virtually noise-free correlation spectrum is obtained, which is characteristic of the cyanine dye and which may for example be stored in a database.

In contrast to the very noisy absorption signal according to FIG. 1B, the correlation function according to FIG. 2B also shows sharp contours not swamped in noise. It is therefore possible to establish that the correlation function of the absorption shows great similarity with the autocorrelation function according to FIG. 2A, even with 500-fold dilution of the cyanine dye. If it is necessary to decide whether the particular cyanine dye is contained in the solution, then the correlation function according to FIG. 2B can be compared with the correlation function according to FIG. 2A, for example by means of pattern recognition, and a probability that the cyanine dye is contained in the solution can be calculated. In this way, it is possible to carry out a verification step in which this probability is determined.

FIG. 3 represents a device for carrying out the method according to the invention in a possible exemplary embodiment. The device comprises a sample holder 310 which, in this exemplary embodiment, is designed as a cuvette for holding a liquid medium 312 in the form of a solution.

The device according to FIG. 3 furthermore comprises a beam source 314. This beam source 314 may, for example, be a tunable laser, for example a diode laser or a dye laser. As an alternative or in addition, it is also possible to provide light-emitting diodes, for example a light-emitting diode array which can be switched between light-emitting diodes of different emission wavelengths. In this exemplary embodiment, this beam source 314 fulfills a double function, and operates both as a first beam source for generating first analysis radiation 316 and as a second beam source for generating second analysis radiation 318.

A first detector 320 and a second detector 322 are furthermore provided, which are arranged so that the first detector detects the part 324 of the first analysis radiation 316 transmitted by the medium and the second detector 322 detects fluorescent light 326 emitted by the medium 312 in response to the second analysis radiation 318. The arrangement of the detectors 320 and 322 is in this case selected so that transmission light 324 and fluorescent light 326 are mutually perpendicular, the transmission light being measured in extension of the first analysis radiation 316. An optical chopper 328, which is configured for example in the form of a segmented wheel, is furthermore provided in the beam path of the second analysis radiation 318. Such choppers 328 are known to the person skilled in the art, and are used to periodically interrupt the second analysis radiation 318. An optical edge filter 330 is furthermore provided in the beam path of the fluorescent light 326.

The second detector 322 is connected to a lock-in amplifier 332, which itself is in turn connected to the chopper 328.

A central control and evaluation unit 334 is furthermore provided. In this example, this central control and evaluation unit 334 is connected to the chopper 328, the lock-in amplifier 332, the beam source 314 and the first detector 320. Via an input/output interface 336, which is represented only symbolically in FIG. 3, an experimenter can operate the central control and evaluation unit 334 and obtain information from the central control and evaluation unit 334. This input/output interface 336 may, for example, comprise a keyboard, a mouse or a tracker ball, a screen, an interface for a mobile data memory, an interface to a data telecommunication network or similar input and/or output means known to the person skilled in the art.

The central control and evaluation unit 334 in turn comprises correlation electronics 338 which, in this example, are connected to the first detector 320 (optionally via corresponding amplifier electronics or signal conditioning electronics). The central control and evaluation unit 334 furthermore comprises decision logic 340, which is connected to the correlation electronics 338. An evaluation device 342 is furthermore provided, which is in turn connected to the decision logic 340. Lastly, a central computation unit 344 is also provided, for example in the form of one or more processors, which is connected to the three said components 338, 340 and 342 and is capable of controlling these components. The central computation unit 344 also has a data memory 346, for example in the form of one or more volatile and/or non-volatile memories.

It should be noted here that the arrangement according to FIG. 3 may also be readily modified by a person skilled in the art and adapted to the corresponding situation. For example, said components of the central control and evaluation unit 334 need not necessarily be separate, rather they may be physically combined components. For example, one electronic device may fulfill the function of a plurality of components of the central control and evaluation unit 334. The lock-in amplifier 332 may also be fully or partially integrated into the central control and evaluation unit 334. Besides these, it is also possible to provide additional components (not shown in FIG. 3), in particular filters, amplifiers, additional computer systems or the like, for example in order to further clean up the signals of the detectors 320, 322. The functions of the components of the central control and evaluation unit 334 may furthermore be fully or partially undertaken by corresponding software components instead of hardware components. For example, the decision logic 340 need not necessarily involve hardware components, and a corresponding software module, for example, may be provided instead. Similar considerations apply to the correlation electronics 338 and the evaluation device 342. For example, some or all of these components may be computer programs or computer program modules, which run for example on the central computation unit 344.

The functionality of the device according to FIG. 3 will be explained by way of example below with reference to a schematic flow chart represented in FIG. 4 for a possible exemplary embodiment of the method according to the invention. The method steps symbolically represented in FIG. 4 need not necessarily be carried out in the order presented, and it is also possible to carry out other method steps not represented in FIG. 4. Method steps may also be carried out in parallel or repeatedly.

In a first method step 410, the medium 312 is exposed to first analysis radiation 316 by the beam source 314, the wavelength λ of the first analysis radiation 316 being varied. For example, this may involve a so-called scan in which the wavelength λ is tuned over a particular range. The second analysis radiation 318 is not active during this method step 410. The chopper 328 is also switched to maximum transmission, and it does not interrupt the beam of the first analysis radiation 316.

In method step 412, the transmission light 324 of this first analysis radiation 316 is recorded by the first detector 320 and a corresponding detector signal is generated. This detector signal is forwarded to the correlation electronics 338, during which additional signal conditioning steps may also be optionally be inserted, for example filtering or the like. For the correlation electronics 338, the signal generated in this way represents a “raw response function” A′ of the wavelength λ′ of the first analysis radiation 316. For example, the beam source 314 may be driven by the central control and evaluation unit 334 so that the correlation electronics 338 at all times have information about the wavelength λ′ of the first analysis radiation 316 which has just been emitted.

Cleaning of the raw response function A′(λ′) takes place in method step 414, which is carried out for example in the correlation electronics 338. For this cleaning, which has been described above, it is possible to employ information in the data memory 346. In this way, for example, known solvatochromicity effects can be cleaned up in step 414 by transforming the wavelength □′ into a wavelength λ (see Equation 6). As an alternative or in addition, corresponding background signals H(λ′) may also be cleaned up from the raw response function A′(λ′) according to the aforementioned Equation 5. Information stored in the data memory 346, for example, may likewise be employed for this as well. In this way, the spectral response function A(λ) is generated from the raw response function A′(λ′) in method step 414.

In the subsequent correlation step 416, the spectral response function A(λ) generated in this way is subjected to correlation formation. Depending on whether the first analysis radiation 316 has been tuned continuously or step-wise, Equation 1 or Equation 3 may for example be used for this. For example, pattern functions R(λ) which are stored in the data memory 346 may be employed. To this end, for example, the central computation unit 344 may contain a database which, for example, is again stored in the data memory 346.

A correlation signal is in this way generated in method step 416, for example a correlation signal according to the correlation signal represented in FIGS. 2A and 2B. This correlation signal can be examined for particular patterns in method step 418, which may be done in the scope of a pattern recognition step. In this way, as described above, information can be obtained about the probability of the presence of a particular compound in the medium 312. This information about the probability may, for example, be output to the user or experimenter via the input/output interface 336. The verification step 420, which comprises the substeps 410 to 418, is then concluded in this exemplary embodiment by completion of the pattern recognition step 418.

A decision step 422 is then carried out on the basis of the result of the verification step 420, i.e. for example the probability that a particular compound is present in the medium 312. This decision step 422 may, for example, be carried out in the decision logic 340 in the device according to FIG. 3. For example, it is possible to set thresholds which are optionally stored in the data memory 346. It is thus possible to specify that the presence of the compound should be assumed above a particular probability, while its absence should be assumed below this. In the decision step 422 in this example, a decision is correspondingly made as to whether a subsequent analysis step 424 will be carried out (“presence”, 426 or “absence of the compound”, 428).

Method step 430, in which corresponding information is output to a user or experimenter, may thus be carried out for the case of absence of the compound (428 in FIG. 4). The method is subsequently terminated in step 432.

If the presence of the compound (426 in FIG. 4) is concluded in the decision step 422, however, then the analysis step 424 is initiated. In the exemplary embodiment represented here, this analysis step 424 is based on a quantitative fluorescence analysis of the medium 312, or the compound contained in this medium. A lock-in method is used so as to generate a maximally noise-free signal of high intensity even with low concentrations of the chemical compound (for example the cyanine dye).

In a first substep 434 of the analysis step 424, the entire optical device is switched over according to the analysis step 424 now to be carried out. Accordingly, for example, the lock-in amplifier 332 and the chopper 328 are started. The first analysis radiation 316 may also be switched off, if this has not already been done.

The emission of the second analysis radiation 318 by the beam source 314 is subsequently started in a substep 436. This second analysis radiation 318 may, for example, be emitted at a fixed excitation wavelength λ_{EX}. As an alternative, a corresponding scan may likewise be carried out here. With excitation at a fixed excitation wavelength λ_{EX}, for example, it is possible to select an excitation wavelength λ_{EX} which is optimally matched to the dye (now known to be present in the medium 312) or the chemical compound. It is thus possible to select an excitation wavelength λ_{EX} which, for example, corresponds to an absorption maximum of this chemical compound.

The fluorescent light 326 emitted by the medium 312, or the chemical compound, is then detected by means of the second detector 322. This gives rise to a spectral analysis function B(λ_{EX}, λ_{RES}) as a function of the wavelength λ_{EX} of the second analysis radiation and as a function of the wavelength KRES of the fluorescent radiation 326. This spectral analysis function B(λ_{EX}, λ_{RES}) is recorded integrally in this exemplary embodiment, however, such that all fluorescent light 326 with a wavelength λ_{RES} which is greater than a limit wavelength of the edge filter 330 is integrally detected by the detector 322.

The second analysis radiation 318 is periodically interrupted by the chopper 328, for example by means of a segmented chopper wheel or a corresponding perforated disk. The frequency of this interruption is forwarded from the chopper 328 to the lock-in amplifier 332. Frequency mixing of a reference signal of the chopper 328 (for example a cosine signal at the interruption frequency f) takes place in this lock-in amplifier 332. After this frequency mixing, the signal generated in this way is filtered by a lowpass filter and forwarded to the evaluation device 342. The described frequency mixing and filtering correspond to a “hardware implementation” of the computing operation represented in Equation 9. In this way, a signal B(λ, λ_{EX}, λ_{RES}) according to Equation 9 is forwarded from the lock-in amplifier 332 to the evaluation device 342.

The concentration of the chemical compound in the medium 312 is subsequently calculated in the evaluation device 342 in substep 440. Since the exemplary embodiment according to FIG. 3 involves a fluorescence analysis, the concentration of the chemical compound is typically proportional approximately to the intensity of the fluorescent light and therefore to the signal B(λ, λ_{EX}, λ_{RES}) generated by the lock-in amplifier 332. The edge filter 330 prevents fluorescent light 326 from being mixed with second analysis radiation originating from the beam source 314, which would make the quantitative analysis more difficult. The calculation of the concentration may thus be carried out with the aid of calibration factors stored in the data memory 346, for example, which have themselves been determined in previous calibration measurements.

The result of the concentration measurements in substep 440 may itself subsequently be stored in the data memory 346. As an alternative or in addition, an output via the input/output interface 336 to a user may also take place in substep 442. The method may subsequently be terminated in substep 444, or further samples can be examined.

Lastly, FIGS. 5A and 5B represent an example of a result of the substep 440 for determining the concentration of the chemical compound in the medium 312, which demonstrates the reliability of the method described above. The anthraquinone dye according to the aforementioned Example 1, as the chemical compound, was in this case added at various concentrations c to diesel fuel from the company Aral, as the medium 312, and identified and quantified according to the method described above.

A beam source 314 having seven reference-stabilized light-emitting diodes (LEDs) of the wavelengths 470 nm, 525 nm, 615 nm, 700 nm, 750 nm, 780 nm and 810 nm was used for this, the beam source 314 being switchable between the emission light of these light-emitting diodes. A lock-in method was again used in the analysis step 424. Instead of modulation with the aid of a chopper 328 as in the exemplary embodiment according to FIG. 3, however, the intensity of the second analysis radiation 318 emitted by the light-emitting diodes was modulated directly in this exemplary embodiment. To this end, the currents of the LEDs were modulated by a microcontroller (for example of the central computation unit 344 in the central control and evaluation unit 334).

Both the transmission light 324 and the fluorescent light 326 were recorded in this example for the analysis step 424 and used for determining the concentration c. Two separate spectral analysis functions B(λ_{EX}, t) were thus obtained in this example, which were evaluated separately. The intensity of the transmission light 324 was measured by a silicon photocell as the first detector 320, digitized with the aid of a microcontroller contained in the central control and evaluation unit 334 (in this example the same microcontroller as that used for the LED control) and evaluated according to the lock-in method described above. Similarly, the fluorescent light 326 was recorded through a color filter 330 of the RG 850 type by a further silicon photodiode as the second detector 322, digitized with the aid of the microcontroller and evaluated.

The result of these quantitative analyses is represented in FIG. 5A (absorption measurement) and 5B (fluorescence measurement). The actual weigh-in concentration of the anthraquinone dye in the diesel fuel is represented on the x axis, while the weigh-in concentration determined for the absorption measurement (FIG. 5A) or the fluorescence measurement (FIG. 5B) in the analysis step 424 is respectively represented on the y axis. Four different measurement runs (measurement 1 to measurement 4) are represented in each case.

The results show, on the one hand, that the different measurement results are in good agreement and that the method thus leads to results with good reproducibility. It can furthermore be seen that, apart from slight deviations in the range below approximately 200 ppb, there is a very good match between the actual weigh-in concentrations and the concentrations c determined by the absorption measurement or fluorescence measurement.

To this extent, this example shows that both absorption measurements and fluorescence measurements according to the described method are outstandingly suitable for the analysis step 424. For example, it is thus possible to take statistical averages of the concentrations determined by means of different measurement methods (for example the concentration c determined according to FIG. 5A by the absorption measurement and the concentration c determined according to FIG. 5B by the fluorescence measurement) so as to further increase the accuracy of the method according to the invention.

List of References

| | |
|---|---|
| 310 | sample holder |
| 312 | medium |
| 314 | beam source |
| 316 | first analysis radiation |
| 318 | second analysis radiation |
| 320 | first detector |
| 322 | second detector |
| 324 | transmission light |
| 326 | fluorescent light |
| 328 | chopper |
| 330 | edge filter |
| 332 | lock-in amplifier |
| 334 | central control and evaluation unit |
| 336 | input/output interface |
| 338 | correlation electronics |
| 340 | decision logic |
| 342 | evaluation device |
| 344 | central computation unit |
| 346 | data memory |
| 410 | exposure to first analysis radiation |
| 412 | detection of the raw response function A(λ) |
| 414 | cleaning of the raw response function, generation of a spectral |
| | response function |
| 416 | correlation formation |
| 418 | pattern recognition step |
| 420 | verification step |
| 422 | decision step |
| 424 | analysis step |
| 426 | presence of the compound |
| 428 | absence of the compound |
| 430 | output of information to user |
| 432 | end of the method |
| 434 | start chopper and lock-in amplifier |
| 436 | start second analysis radiation |
| 438 | detection of fluorescent light |
| 440 | calculation of the concentration |
| 442 | output of the concentration |
| 444 | end of the method |

1: A method for detecting at least one chemical compound V comprised in a medium, comprising a verification step which is used to determine whether V is comprised in the medium, and furthermore comprising an analysis step in which a concentration c of the at least one chemical compound V is determined,
the verification step comprising the following substeps:
(a1) the medium is exposed to a first analysis radiation of a variable wavelength λ, the wavelength λ assuming at least two different values;
(a2) at least one spectral response function A(λ) is generated with the aid of the radiation absorbed and/or emitted and/or reflected and/or scattered by the medium in response to the first analysis radiation;
(a3) at least one spectral correlation function K(δλ) is formed by spectral comparison of the at least one spectral response function A(λ) with at least one pattern function R(λ+δλ), the at least one pattern function R(λ) representing a spectral measurement function of a medium comprising the chemical compound V and δλ, being a coordinate shift;
(a4) the at least one spectral correlation function K(δλ) is examined in a pattern recognition step, and a conclusion is made as to whether the at least one chemical compound V is comprised in the medium;
the analysis step comprising the following substeps:
(b1) the medium is exposed to at least one second analysis radiation having at least one excitation wavelength λ_{EX};
(b2) at least one spectral analysis function B(λ_{EX}, λ_{RES}) is generated with the aid of the radiation of the response wavelength λ_{RES} absorbed and/or emitted and/or reflected and/or scattered by the medium in response to the second analysis radiation of the wavelength λ_{RES} and the concentration c is deduced therefrom,
wherein the verification step and the analysis step are carried out separately and in that the analysis step is carried out only if the verification step has established that the compound V is comprised in the medium.

2: The method as claimed in claim 1, wherein the spectral correlation function K(δλ) is formed from the at least one spectral response function A(λ) and the at least one pattern function R(λ) according to one or more of the following Equations (1) to (4):
$$K ( δλ ) = \frac{1}{N} \cdot {\int }_{λ} A ( λ ) \cdot R ( λ + δλ ) \cdot d λ , \qquad ( 1 )$$
where N is a normalization factor,
$$N = {\int }_{λ} A ( λ ) \cdot R ( λ ) \cdot d λ \qquad ( 2 )$$
or according to a corresponding Riemann sum
$$K ( δλ ) = \frac{1}{{N}^{*}} \cdot {\sum }_{i} {A}_{i} ( {λ}_{i} ) \cdot {R}_{i} ( {λ}_{i} + δλ ) \cdot {Δλ}_{i} \qquad ( 3 )$$
where summation is carried out over a number of support points i, Δλᵢ being an interval length of the respective support point i and N* being a normalization factor,
$${N}^{*} = {\sum }_{i} {A}_{i} ( {λ}_{i} ) \cdot {R}_{i} ( {λ}_{i} ) \cdot {Δλ}_{i} . \qquad ( 4 )$$

3: The method as claimed in claim 1, wherein more than one spectral response function A(λ) is generated in the substep (a2).

4: The method as claimed in claim 1, wherein at least one raw response function A′(N) is firstly recorded in substep (a2) and the at least one raw response function is subsequently transformed as follows into the at least one spectral response function A(λ):
A(λ)=A′(λ′)−H(λ′) (5)
where λ is a shift-corrected wavelength with
λ=λ′=Δλ_{S}(6)
where Δλ_{S} as is a predetermined wavelength shift and where H(λ′) is a predetermined background function.

5: The method as claimed in claim 4, wherein the wavelength shift Δλ_{S} is empirically determined by at least one of the following methods:
a spectral response function of a medium comprising the compound V is compared with a spectral response function of a reference medium comprising the compound V and/or with a reference response function, and the wavelength shift Δλ_{S} is determined from a spectral shift according to Equation (6);
a spectral correlation function K(δλ) is formed according to substep (a3) by comparing a spectral response function of the compound V in the medium with a spectral response function of the compound V in another medium and/or with a standard response function.

6: The method as claimed in claim 4, wherein the spectral background function H(λ′) is empirically determined by at least one of the following methods:
a spectral response function of the medium comprising the compound V is compared with a spectral response function of the medium not comprising the compound V and/or with a reference response function, and the spectral background function H(λ′) is determined from a deviation;
the spectral background function H(λ′) is determined by fitting a first spectral correlation function K(δλ), formed by spectral comparison of the at least one spectral response function A(λ) with the at least one pattern function R(λ) according to substep (a3), to a second spectral correlation function K_{Auto}(δλ) formed by spectral comparison of the at least one pattern function R(λ) with itself according to substep (a3).

7: The method as claimed in claim 4, wherein at least one spectral background function H(λ′) and/or at least one wavelength shift Δλ_{S} is taken from a database.

8: The method as claimed in claim 1, wherein the excitation wavelength λ_{EX} of the second analysis radiation assumes at least two different values.

9: The method as claimed in claim 1, wherein the at least one spectral analysis function B(λ_{EX}, λ_{RES}) comprises a fluorescence function.

10: The method as claimed in claim 1, wherein the at least one spectral analysis function B(λ_{EX}, λ_{RES}) is recorded integrally over a wavelength range of the response wavelength λ_{RES}.

11: The method as claimed in claim 1, wherein a lock-in method is used in the analysis step, at least one second analysis radiation of the excitation wavelength λ_{EX} modulated periodically with a frequency f being used.

12: The method as claimed in claim 11, wherein the at least one spectral analysis function is recorded with time resolution as B(λ_{EX}, λ_{RES}, t).

13: The method as claimed in claim 12, wherein the concentration c of the compound V is determined according to c=f(B), where f is a known, empirically determined or analytically derived function of the spectral analysis function B,
$$\begin{matrix}c = {K}_{1} \cdot B ( τ , {λ}_{EX} , {λ}_{RES} ) \\ or & ( 7 ) \\ c = {K}_{2} \cdot log B ( τ , {λ}_{EX} , {λ}_{RES} ) \\ with & ( 8 ) \\ B ( τ , {λ}_{EX} , {λ}_{RES} ) = {\int }_{0}^{τ} B ( {λ}_{EX} , {λ}_{RES} , t ) \cdot cos ( 2 π \cdot f \cdot t ) d t & ( 9 )\end{matrix}$$
where τ is a time constant, and where K₁ and K₂ are predetermined proportionality constants.

14: The method as claimed in claim 1, wherein the detection of the at least one chemical compound is carried out in order to identify a mineral oil and/or in order to check the authenticity of goods.

15: A device for carrying out the method as claimed in claim 1, comprising
at least one sample holder for holding the medium;
at least one first beam source for generating the first analysis radiation;
at least one first detector for detecting the radiation absorbed and/or emitted and/or reflected and/or scattered by the medium in response to the first analysis radiation;
at least one set of correlation electronics having correlation means for forming the spectral correlation function K(δλ) and having pattern recognition means for carrying out the pattern recognition step;
at least one second beam source for generating the second analysis radiation;
at least one second detector for detecting the radiation absorbed and/or emitted and/or reflected and/or scattered by the medium in response to the second analysis radiation,
characterized by
an evaluation device for determining the concentration c of the at least one chemical compound V comprised in the medium and by a decision logic for starting the analysis step as a function of the result of the pattern recognition step.

16: The device as claimed in claim 15,
further comprising at least one modulator for periodically modulating the second analysis radiation, and at least one lock-in amplifier.

17: The device as claimed in claim 15, wherein the at least one first beam source comprises a multiplicity of individual radiation sources with predetermined spectral properties, and the at least one first beam source is switchable between the individual radiation sources.

18: The method as claimed in claim 3, wherein the more than one spectral response function A(λ) is a transmission function T(λ) and an emission function E(λ), and the emission function E(λ) comprises a fluorescence function.

19: The method as claimed in claim 12, wherein the at least one spectral analysis function is recorded, with time resolution as B(λ_{EX}, λ_{RES}, t), integrally over a wavelength range of the response wavelength λ_{RES} as B(λ_{EX}, t).

20: The device as claimed in claim 15, wherein the at least one second beam source is identical to the at least one first beam source, and the at least one second detector is different from the at least one first detector.
